(19) United States
(12) Patent Application Publication
(10) Pub. No.: US 2025/0335522 A1
(43) Pub. Date: Oct. 30, 2025

(54) SYSTEM AND PROCESS FOR MATCHING USERS WITH EACH OTHER VIA AN ACTIVITY

(71) Applicant: Nicholas George RAMIREZ, Lindenhurst, NY (US)

(72) Inventor: Nicholas George RAMIREZ, Lindenhurst, NY (US)

(21) Appl. No.: 19/191,126

(22) Filed: Apr. 28, 2025

Related U.S. Application Data
(60) Provisional application No. 63/639,926, filed on Apr. 29, 2024.
(60) Provisional application No. 63/704,830, filed on Oct. 8, 2024.

(51) Int. Cl. G06F 16/9535; G06Q 50/00; H04W 4/029

(52) U.S. Cl. CPC G06F 16/9535; G06Q 50/01; H04W 4/029

(57) ABSTRACT

There is a system and a process for coordinating users over a computer network. This system and process includes a network of computers having at least one microprocessor. The microprocessor is configured to perform the following tasks: First, registering at least one user on a computer network. Next, storing a first set of data about the user in the computer network. Next, tracking the location of events, wherein each event has a particular geographic location. Next, tracking an activity of users with respect to said events. Next, reporting on whether at least one user has arrived at any one of these events. Next, matching at least one user with another user on the network at the at least one event. Thus, there is created a system and a process for matching users to each other, particularly via events and other activities.

### CROSS REFERENCE TO RELATED APPLICATIONS

This application is a non-provisional application that hereby claims priority to U.S. Provisional application Ser. No. 63/639,926 filed on Apr. 29, 2024, and U.S. provisional Patent Application Ser. No. 63/704,830 filed on Oct. 8, 2024, the disclosures of which are hereby incorporated herein by reference by its entirety.

### BACKGROUND OF THE INVENTION

The invention relates to a system and a process for matching users based upon an activity that the users are engaged in. This system is coordinated over a computer network so that the different users once they register on the network, they can inform other users of their activity and then find ways to engage in live activities together.

### SUMMARY

There is a system and a process for coordinating users over a computer network. This system and process includes a network of computers having at least one microprocessor. The microprocessor is configured to perform the following tasks: First, registering at least one user on a computer network. Next, storing a first set of data about the user in the computer network. Next, tracking the location of events, wherein each event has a particular geographic location. Next, tracking an activity of users with respect to said events. Next, reporting on whether at least one user has arrived at any one of these events. Next, matching at least one user with another user on the network at the at least one event. Thus, there is created a system and a process for matching users to each other, particularly via events and other activities.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a flow chart for the process for registering on a social media application;

FIG. 2 is a view of a computer network for servicing the social media application;

FIG. 3A is a view of the computer components for a server shown in FIG. 2;

FIG. 3B is a view of a portable device shown in FIG. 2;

FIG. 4 is the process for geolocating users on the application;

FIG. 5 is a process for setting a priority of a search for users on the application;

FIG. 6 is a process for weighting the hobbies of the users to match the users;

FIG. 7A shows the matching of a first set of hobbies;

FIG. 7B shows the matching of four hobbies between the users;

FIG. 8 is a map showing the connection of users based upon the user's home address as well as the user's hobby or activity address;

FIG. 9A is a view of user matches based upon activities and points;

FIG. 9B is a view of user matches based upon hobbies;

FIG. 10 is a process for limiting access to the users on the application;

FIG. 11 is a process for registering and tracking hobbies and activities through the system;

FIG. 12 is a flow chart for the process for certifying a hobby or activity;

FIG. 13 is a flow chart for setting a hobby or activity hotspot;

FIG. 14 is visual view of a user making connections;

FIG. 15 is a view of a user on a screen;

FIG. 16 is a view of a flow chart for the process for a connect more process;

FIG. 17 shows the process wherein once the user purchases more access;

FIG. 18 shows the process for setting up a child account;

FIG. 19 sets the process for allowing couples to register as an account;

FIG. 20 this outlines the steps for a priority search across profiles;

FIG. 21A is a view of a map for connecting users;

FIG. 21B is a view of a map for two lines for connecting users;

FIG. 22A is a view of a map using a rectangle for an area to connect users;

FIG. 22B is a view of a map for using another shape for outlining the area for connecting two different users;

FIG. 23A is a view of another map having both east west lines and north south lines;

FIG. 23B is a view of a line having angular adjustability and two additional zones of searching;

FIG. 24 is a view of a map having multiple different search lines;

FIG. 25 is a flow chart for the additional steps for searching based upon lines;

FIG. 26 is a flow chart for the steps for simultaneously searching in two different zones;

FIG. 27 is a flow chart for connecting users and businesses with hobbies; and

FIG. 28 is a flow chart for creating events and locating the events on a map.

### DETAILED DESCRIPTION

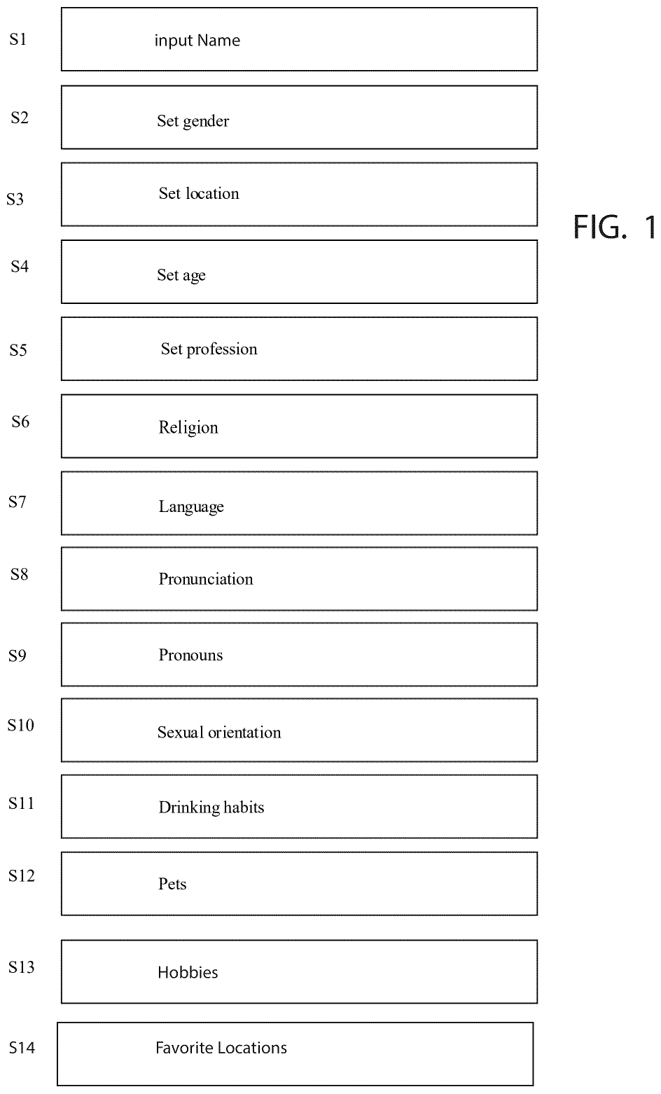

Referring in detail to the drawings, FIG. 1 is a flow chart for the process for registering on a social media application. This process starts with step S1 wherein the user registers their name and contact information with the network. The contact information can include the user's phone number, their email address and any other contact information provided in step S1. Next, in step S2 the user can set their gender.

Gender can include Male, Female or other. Next, the user can set their location such as their home address or the address that they would like to be identified with. Next, in step S4, the user can set their age with the system by providing their birth date. Next, in step S5, the user can set their profession. For example, the user can indicate that they are a carpenter, plumber, electrician, lawyer, secretary, police officer, doctor etc. Next, in step S6 the user can set their religion. Religion can include Christian, Jewish, Catholic, Muslim, Buddhist, etc. Next, in step S7 the user can set their language preference such as English, Spanish, Chinese, Japanese etc. Next, in step S8 the user can set their preferred pronunciation for their name. Next, in step S9 the user can set their preferred pronouns. Next, in step S10 the user can set their preferred sexual orientation such as straight, bisexual or homosexual etc. Next, in step S11 the user can set their drinking habits such as abstaining from alcohol, using alcohol, light drinker etc. Next, in step S12 the user can set whether they have pets, such as dogs, cats, birds, or others. Next, in step S13 the user can set whether they have any particular hobbies such as knitting, golf, running, etc. Next, in step S14 the user can set their favorite locations such as particular bars, restaurants, ball fields, schools or any other suitable locations where the user would spend their time. Once the user is registered, the user can then have access to the system to search the system for other users or to post to other users their activity.

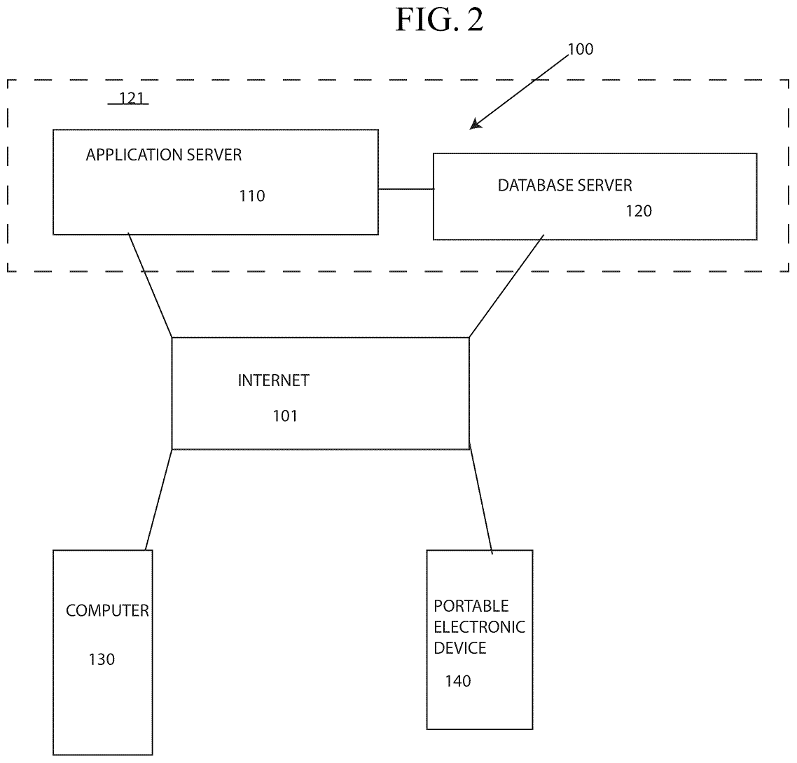

FIG. 2 is a view of a computer network for servicing a social media application. For example, in this embodiment, there is shown the internet 101 which is connected to a computer 130 as well as to a portable electronic device 140. At the opposite end there is an application server 110 as well as a database server 120. Both of these types of servers can be incorporated into a single device such as a single server 100. The application server serves up the application, while the database server 120 stores the data about each of the users. Data on each of the users can be entered into either the application server 110 or the database server 120 via remote computer 130 or through a portable electronic device 140. Portable electronic device 140 can be in the form of an iPad®, an iPhone® or any other form of portable device such as a smartphone.

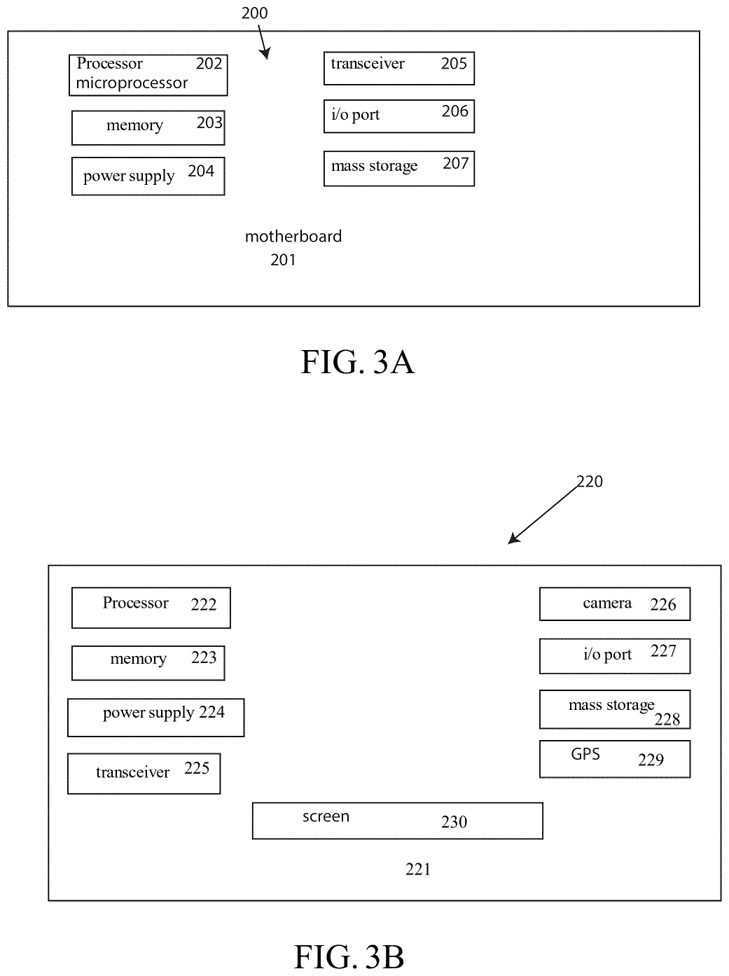

FIG. 3A is a view of the computer components for a server shown in FIG. 2, this view discloses the components of any one of application server 110 or database server 120. For example, there are components 200 having motherboard 201, processor such as microprocessor 202 in the form of a microprocessor, a memory 203 which can comprise a random-access memory. The memory is configured to store the instructions in a non-transitory manner. There is also a power supply 204, a transceiver 205, an i/o port 206, and a mass storage device 207. The mass storage device can be in the form of a hard drive which stores the application, or processes run as shown in FIG. 1.

FIG. 3B shows the schematic layout for the portable electronic device such as a smartphone 140. For example, this portable electronic device can include a motherboard 221, a processor or microprocessor 222, memory 223, a power supply 224, a transceiver 225, a camera 226, an i/o port 227, a mass storage 228 (hard drive), a GPS chip 229 and a screen 230. This device is configured to be able to take in information as well as periodically report on the geographic location of each user. The memory is configured to store the instructions or process in a non-transitory manner.

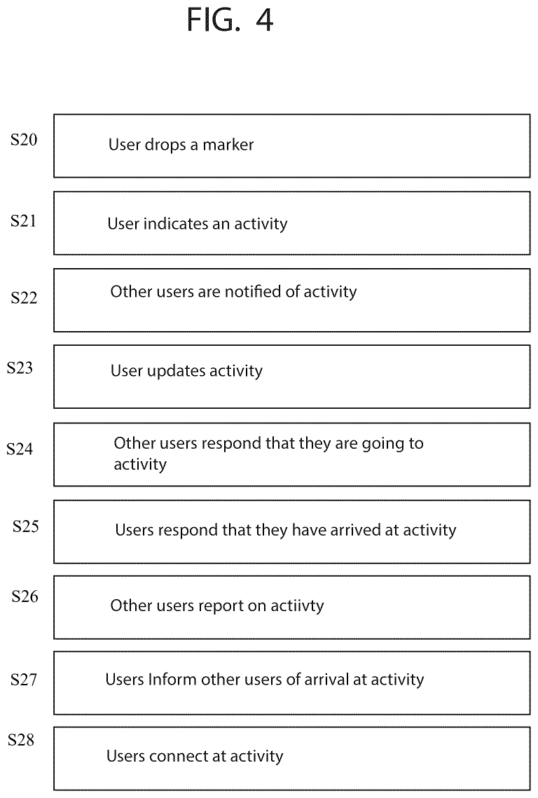

FIG. 4 is a process for a user to indicate their location at an event. For example, in step S20 the user can indicate their location. This occurs with the user operating a portable electronic device 140 having a GPS chip 229. Next, in step S21, the user can indicate an activity that they are doing such as drinking, dancing, attending a concert, a book reading, a sporting event etc. Next, in step S22 the user can then notify other users of their activity. The other users would be those that are either linked to the original user or who are linked to a particular event or location. Next, in step S23 the user can then update their activity to further refine their particular activity. Next, in step S24 other users operating other portable electronic devices or other computers, can link with a first set of users informing other parties of their activities and respond that they are going to their activities. Next in step S25 each user can then respond that they have arrived at their activities. This can occur automatically by the user arriving at the activity and the GPS chip such as chip 229 informing the system that the user has arrived. Or it can occur by the user positively informing other users that they have arrived at a particular location. Next, in step S26, other users can report on their activity. This can include the step that the users indicate that they are dancing, attending a conference, taking a break from the activity etc. Next, in step S27, particular users can inform other users that they have arrived at a particular activity. Next, in step S28, each user can connect with other users at the activity so that each of the users can share in the activity.

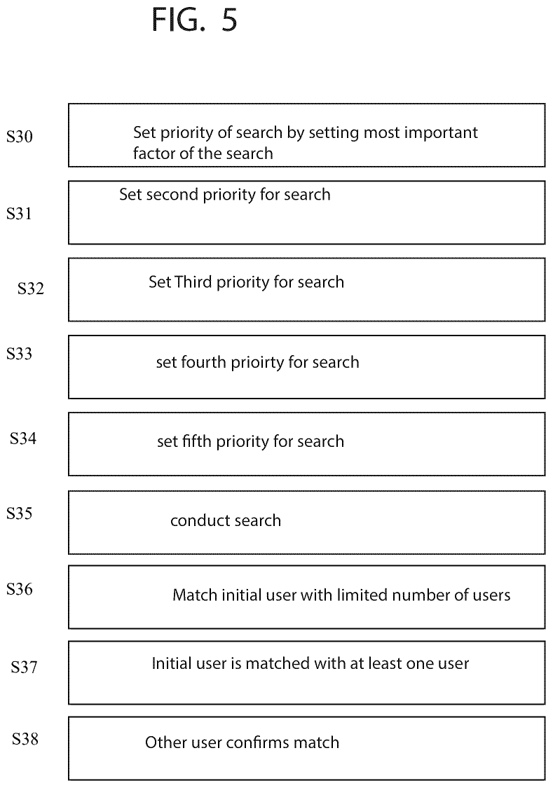

FIG. 5 is a process for setting a priority of a search for users on the application. For example, in step S30 the users can set the priority for the search by setting the most important factor in the search. This most important factor can be, for example geographic location of the user so that it narrows down the users to a particular geographic location. Next, in step S31 the user can set the second priority for the search, this priority can be that the first factor is the most important factor in conducting the search. Next, in step S32, the user can set the third priority for the search. Next, in step S33 the user can set the fourth priority for the search. Next, in step S34, the user can set the fifth priority for the search. Next, in step S35, the user can conduct the search. Next, in step S36, the user can match the initial user with a limited number of users. Next, in step S37 the system can match the initial user with other users. Next, in step S38 the user can confirm the match. All of these actions occur via the computer network outlined in FIG. 2, and via at least one microprocessor such as microprocessor 202, or microprocessor 222 (See FIGS. 3A and 3B).

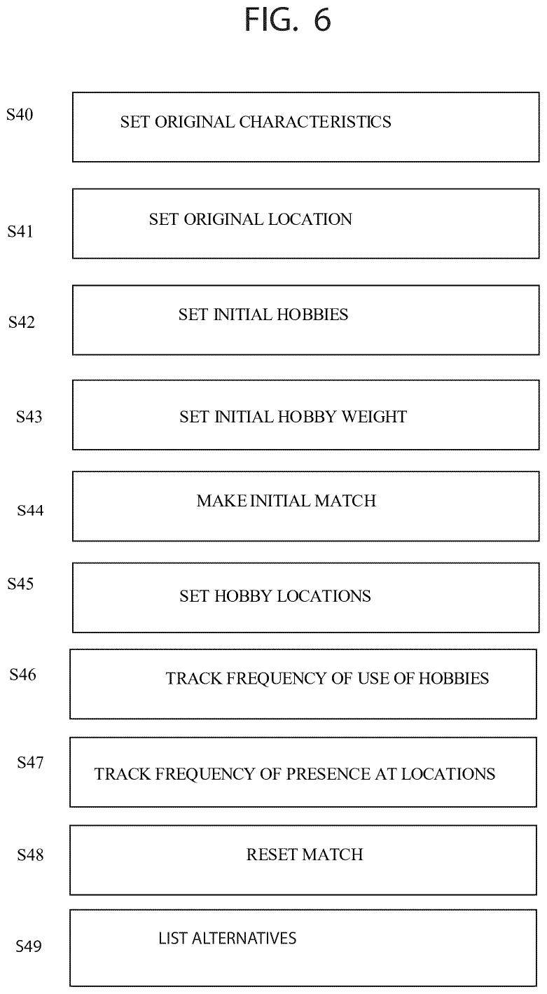

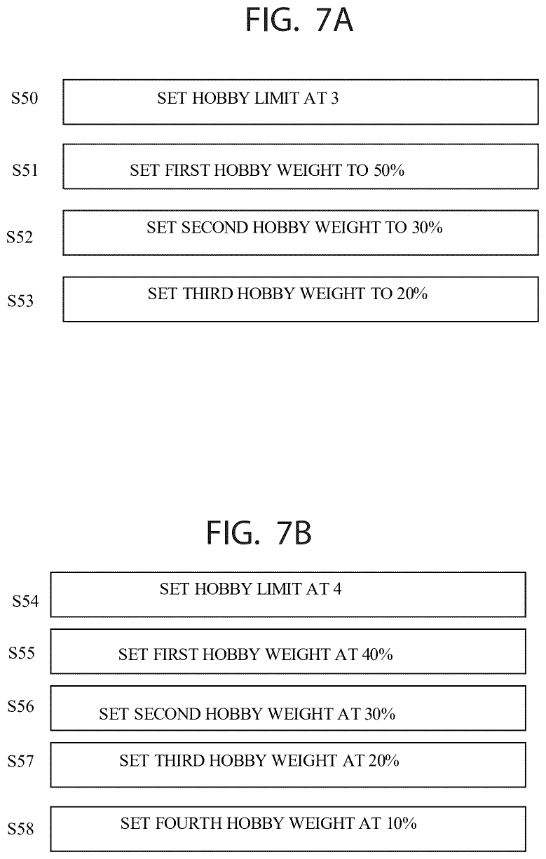

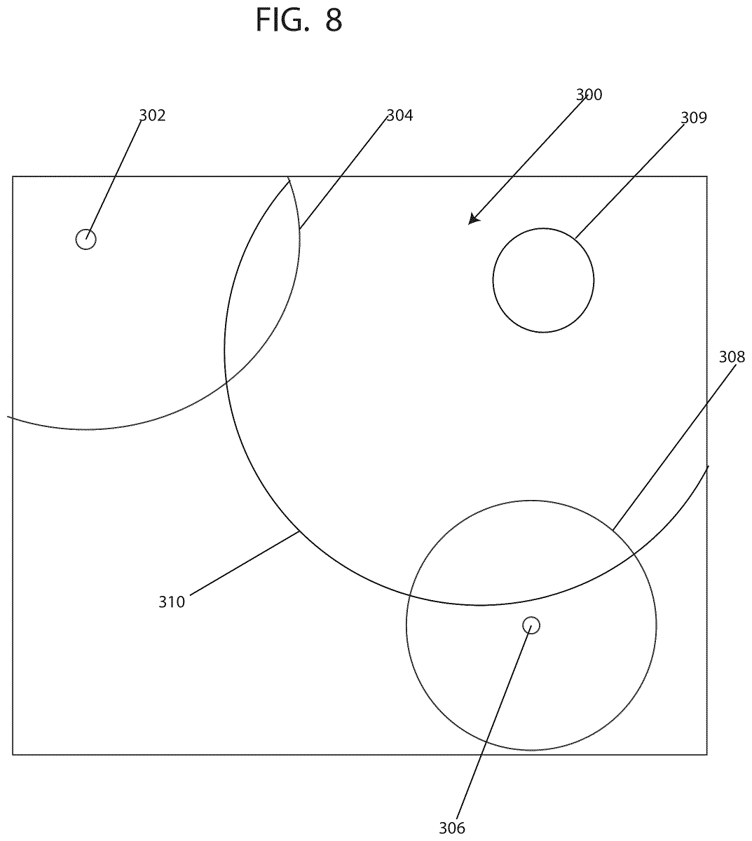

FIG. 6 is a process for weighing the hobbies of the users for matching the users. For example, the process starts with step S40 wherein the original characteristics which are determined in the process shown in FIG. 1. Next in step S41, the system sets the mark for the user's home address to screen for other users. This location of the user's home address is shown in greater detail as point location 302 shown in FIG. 8. Next, with the information input as shown in step S13 on FIG. 1, in step S42 the user can set the initial boundaries. Next, in step S43 the user can set the initial hobby or activity weight. The weighting of the hobbies is shown in FIGS. 7A and 7B. Next, in step S44, the system such as the microprocessor can make a match between two different users. Next, in step S45 the user can set the hobby or activity locations. A hobby or activity location can be at least one additional location of influence by a user. An example of a hobby or activity location is shown in FIG. 8 as additional location 306. Each of these locations, the location 302 or location 306 has a range or radius of influence. Once the hobby or activity location is set, the system can track the frequency of the use of hobbies in step S46 either by the user posting that they are engaging in their hobby or by the user entering the pre-set location of that hobby or activity in step S47. For example, if the hobby or activity is in the form of golf, then the hobby or activity location can be a golf course. If the hobby or activity is basketball, then the hobby location is one of the pre-set locations of basketball courts. If the hobby or activity is that of art, then the hobby location can be an art gallery or a museum.

Depending on the frequency of the postings of the engagement in the hobby or in the locations of the user, the system (using the microprocessor) in step S48 resets any matches of a first user with at least one additional user. Next, in step S49 the system can then list the alternatives (alternative matches) that are outside of an initial geographic location. These alternative matches are those that were not chosen by the initial geographic limitations. However, based upon the hobby or activity matches and the proximity to the outer points of the initial region (See zones of interest or circles 304 and 308 in FIG. 8). Therefore, the system then lists the new alternative matches for the user.

FIG. 7A shows the process for setting the weights of the values of the hobbies or activities. For example, the system or the user can set the total number of hobbies or activities at 3 as shown in step S50. Next, if the number of hobbies or activities is only three (3) then the first hobby or activity weight can be set at 50% with the first hobby listed as the hobby that is most important to the user. Next, in step S52 the second hobby or activity (second most important hobby or activity to the user) that is listed is set to 30%. Next, the third hobby or activity (third most important hobby to the user) is set to 20%. All of these pre-set weights can be individually re-set by the user to have a new set of weights if selected by the user.

Alternatively, if four hobbies or activities are listed as shown in FIG. 7B then in step S54 the user sets four to be the absolute list. Next, in step S55 the system pre-sets the first hobby or activity weight at 40%. Next, in step S56, the system presets the second hobby weight at 30%. Next, in step S57, the system pre-sets the third hobby weight at 20%. Next, in step S58, the system presets the fourth hobby weight at 10%. As indicated above, the user can re-set the weights of these hobbies as they desire. If there are five (5) hobbies, then the weights are set as follows: First hobby weight 35% second hobby weight 25% third hobby weight 20% fourth hobby weight 15% fifth hobby weight 5%.

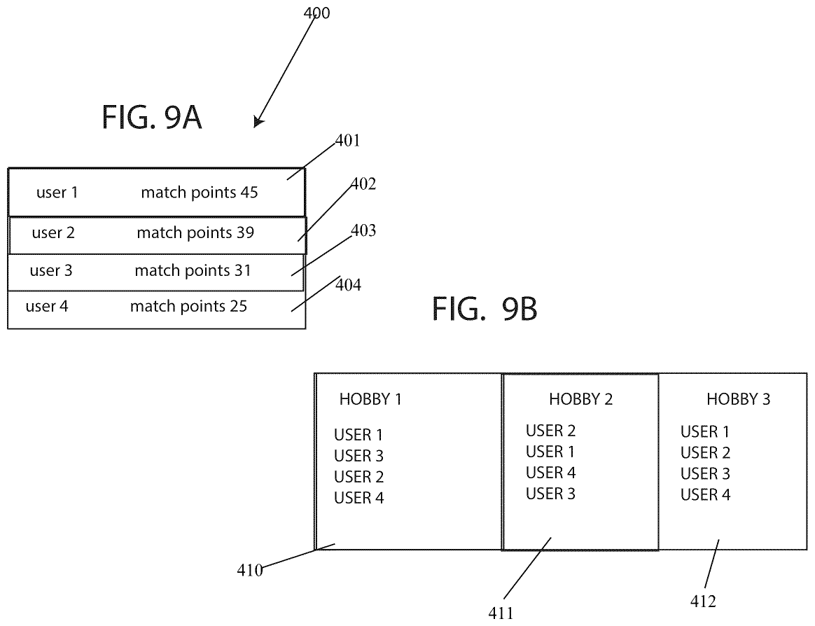

FIG. 8 is a map 300 showing the connection of users based upon the user's home address or location 302 as well as the user's hobby address 306. As shown, the user pre-sets their home location or address by setting either an address, GPS coordinates or placing a pin on a computerized map. Next, the user sets a radius of interest shown by circle 304 for matching with other users such as a 10 mile a 10 kilometer, or 20 mile or 20-kilometer radius. The user can also set a hobby location as well such as a hobby location 306 on map 300. This hobby location can also have a radius of interest set by the user shown by circle 308. This additional radius of interest allows the user to match with other users based upon either the user's home address or the address of the user's hobby of interest. Accordingly, as indicated above, each user can select multiple hobbies and as such can therefore select multiple hobby locations as well. In this way the user is not constrained by simply their home address on a map but can also widen their influence by selecting hobby locations as well as a radius of interest around these hobby locations. There is also another radius which shows the initial radius of another user or circle 309 along with a hobby radius 310 of that user. Thus if one user such as the user 302 having a radius 304 has their radius of interest cross over to another user's radius 309 or to the other user's hobby radius 310 which can cross over to another person's radius or circle 304 or a hobby radius or circle 308 causing a perceived matching of the users such as shown in FIG. 9A or FIG. 9B.

FIG. 9A is a view of a match of users together such that a primary use is matched with other users. For example, with FIG. 9A shows table 400 where a first user is matched with a first set of match points totaling 45 points see row 401. Next another user such as user2 is matched with the primary user with match points 39 see row 402. Next, another user can be matched with the primary user via a total number of matching points such as 31, see row 403. Next, another user can be matched with a primary user via matching points such as 25 see row 404. Thus, depending on the primary hobbies of the user the number of points assigned to the matching hobbies varies based upon the users' hobbies that they have in common.

In addition, as shown in FIG. 9B and table 410, the users are also listed and ranked based upon the different hobbies that the primary user had listed. Therefore, if the primary user had a primary hobby (hobby1) then if other users matched with that hobby, then they would be listed under that hobby designation see column 411. Alternatively, if the primary user (user in location 302 in FIG. 8) is matched with another set of users in a second hobby (hobby2) in column 412 then this list of users is also shown. Next, in another column 413 a third list of users for a third hobby (hobby3) is shown. These other users (any one of users 1-4 could be shown geographically in FIG. 8 such as in location or radius 309 vs. the primary user's location 302.

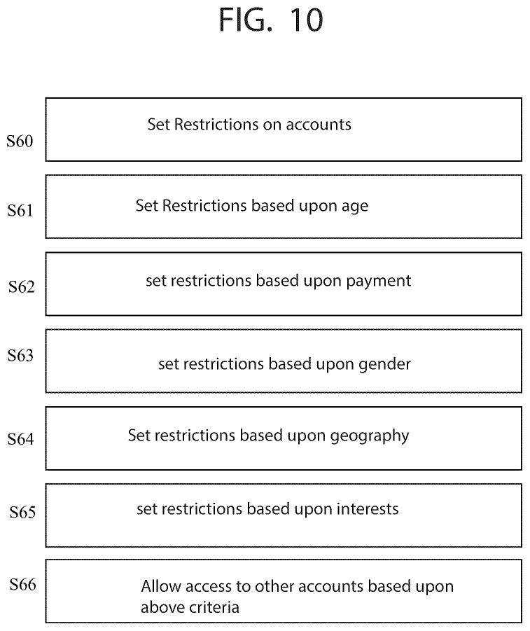

FIG. 10 is a process for limiting access to the users on the application. For example, there are shown a series of restrictions which restrict particular users to have access to information on the system. For example, the process starts in step S60 wherein the system sets restrictions on the accounts. These restrictions can be as shown in step S61 based upon the age of the user, or in step S62 based upon the payment profile of the user. For example, users who are under a pre-set age such as the age of 18 are restricted from certain sections of the account. Alternatively, users who have not paid for particular extended access are also restricted from certain sections of the account.

Next, in step S63, the system can restrict access based upon gender. For example, based upon the user input in FIG. 1 the users can either be restricted to other users based upon their gender selection or voluntarily restrict access to other users based upon their gender. Next, in step S64 the system or user can set restrictions based upon geography. Next, in step S65 the system or user can set restrictions based upon their interests. For example, if the user is only interested in hiking, either the system or the user can be restricted to hearing about inputs from other users only about hiking. Alternatively, if the user selects that they are interested in a particular sports team, their access could be limited to that of the particular sports team, etc. Once all these criteria are set, the system or the user can then grant access in step S66 to their account based upon their selected criteria.

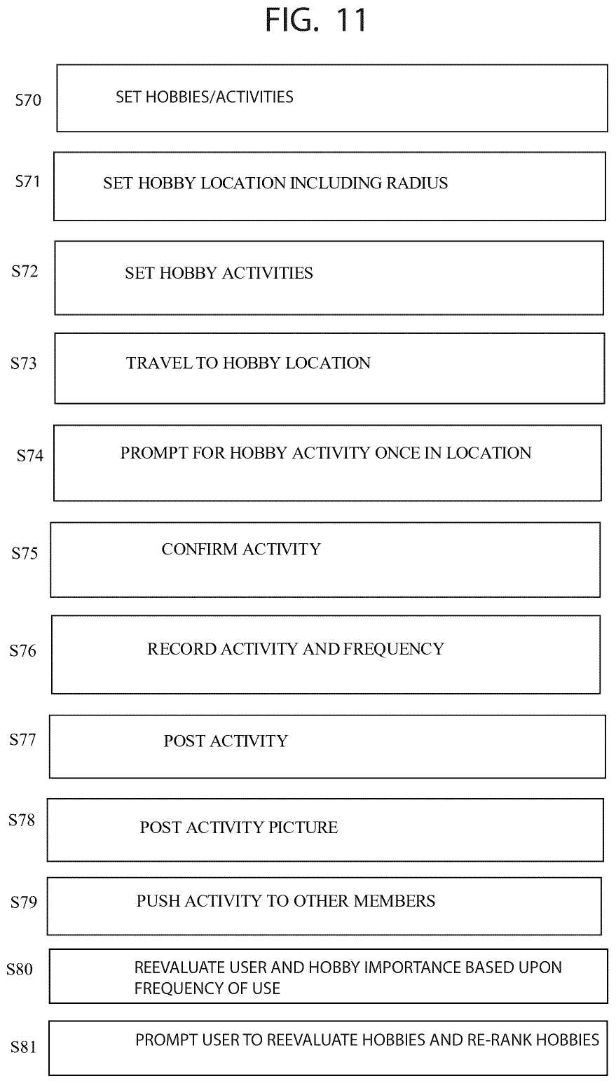

FIG. 11 shows the process for tracking hobbies of a user and for setting the rank of these hobbies for these users. For example, this process starts when the user first sets their hobbies in step S70. Next, in step S71 the user can then set their lobby location (See FIG. 8) via a hobby location radius. Next, in step S72, the user can set the activities of the hobby. For example, if the user's hobby was basketball, then the activity for the hobby would include playing basketball or at least shooting on a basketball hoop. Next, once the radius and activities have been set, the user can travel to the hobby location in step S73, such as location 306 in FIG. 8. Next, in step S74 the system such as microprocessor 202 or 222 can prompt the user for hobby activity once the user is in their primary location. Next, in step S75, the user or the system can confirm the activity. The user can confirm the activity by simply clicking on a button or sending a notification from their portable personal electronic device indicating that the user is participating in that hobby in that hobby location such as a basketball court. Alternatively, the system can record that the user is engaging in the activity if another user tags that primary user as engaging in that particular activity. Next, in step S76 the system such as microprocessor 202 or 222 records that the activity is being performed or has been performed. Next, in step S77 the user can post that the activity has been performed. By posting that the activity has been performed the user notifies the other users of the system that the activity is currently being performed or has just been performed. This then signals to the other users of the system or in the community that an event is either occurring or has occurred. Next, in step S78 the user presents or posts an activity picture. Next, in step S79, the user can push a notification to other users that the activity has been performed or is being performed. This can occur via SMS or MMS messaging where the user directly contacts other users such as in a text, a tweet, a chatroom, email, or other types of electronic notification. Next, in step S80 the system including microprocessor 202 or 222 can reevaluate the user and the hobbies performed by the user and their importance based upon the frequency of use of the hobbies performed by the user. Next, in step S81 the system can prompt the user to re-evaluate the importance of their hobbies and to personally re-rank their hobbies based upon suggestions by the system. This can be performed by the user selectively re-ranking their hobbies or by simply agreeing to a system's suggested preferences for re-ranking based upon the frequency of hobbies performed. This type of re-ranking can be based upon the current ranking of hobbies and the most recent frequency of the hobbies being performed. For example, if a hobby such as golf was ranked below basketball by a user, but the primary user played golf in the last month five times but only played basketball once, as noticed by the system either by the geographic frequency of the primary user, or by the user notifying the system, then the system (microprocessor 202 or 222) would suggest to the user a re-ranking of the hobbies with golf being listed as a primary hobby and basketball being listed as a secondary hobby.

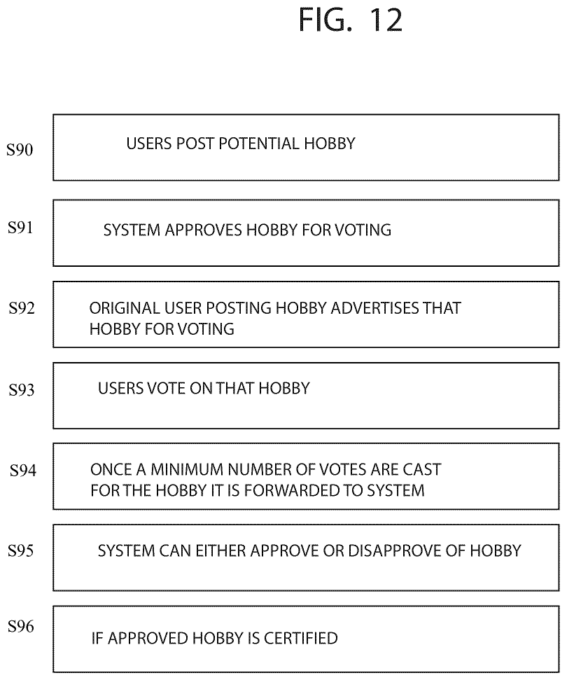

FIG. 12 is a view of a process for approving of a new hobby. For example, the process starts in step S90 wherein a user posts a potential new hobby into the system. The system in the form of both microprocessor 202 or 222 as well as supervisors (users or moderators review the posted hobby and then approve the hobby for voting. For example, if the suggested hobby was illegal such as dueling with pistols, then this hobby would not be approved by the system. However, if the hobby was legal such as basketball or photography then the system would at least initially approve the hobby in step S91. Next, in step S92 once the hobby is at least initially approved, then the original user or the system advertises that hobby for voting. Next, in step S93 the users can vote on that hobby. Next, in step S94 once a minimum number of votes have been cast for that hobby it is forwarded back to the system. In this case, a minimum number of votes can be 5 or 10 or 50 or 100 or any number pre-set by the system. Next, in step S95 the system can either approve or disapprove of the hobby. Next, in step S96 if the hobby is approved by the system, it is then certified.

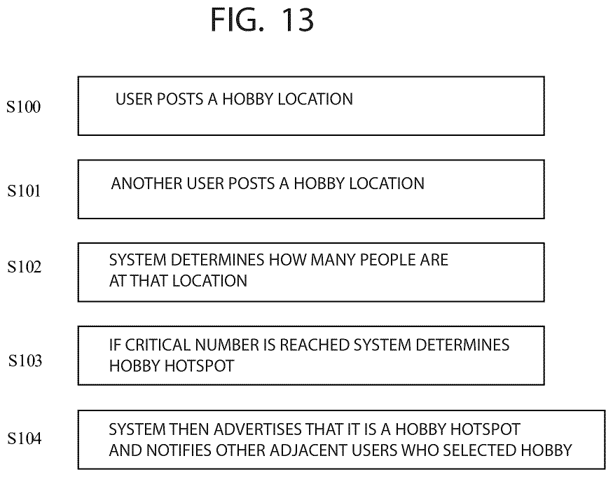

FIG. 13 is a flow chart for creating a hobby hotspot. For example, in this process in step S100 a user posts a hobby location (posts their location while posting that they are performing that hobby). Next, in step S101 another user posts a hobby location. Next, in step S102 the system determines how many people are at a particular location participating in a particular hobby. Next, in step S103 the system determines if a critical number is reached of people performing a hobby at a particular location, then the system can designate that location as a hobby hotspot. The more people that are located in that region performing the hobby, the larger and brighter the indication of the hobby hotspot on the map. Next, in step S104 the system then advertises that location as a hobby hotspot by providing a visual indication on the map as well as selectively notifying other users within a pre-set range (for example within 10 miles, 20 miles or any suitable distance) the users would then be notified of that hobby hotspot. In particular if the users have that hobby listed as one of their hobbies, then they would be notified of a hobby hotspot either via a message, a text or other notification means through the application.

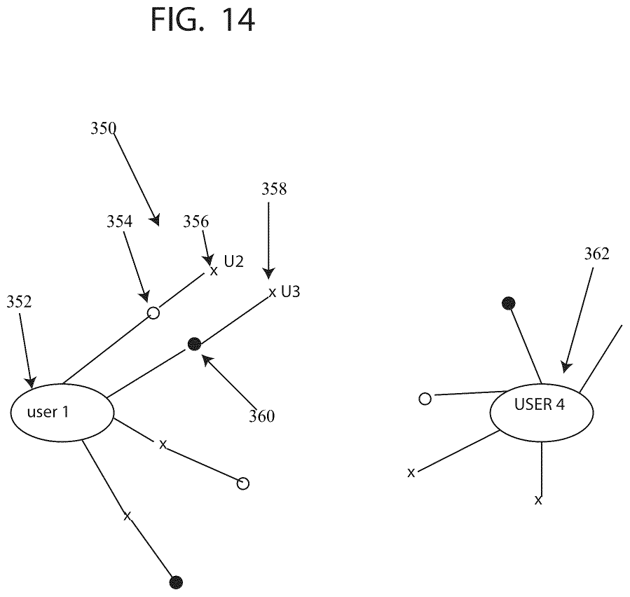

FIG. 14 is a view of two users with connection notifications. For example, the user 1 352 has a connection with a second user at point 354 which shows a hobby connection with an open circle. The x at 356 indicates that there is no other connection or no connection. The user 352 connects with a third user via a main hobby or primary hobby at point 360 which has a darkened circle. At point 358 the first user 352 is shown to have no other connection to the third user. A fourth user 362 is also shown.

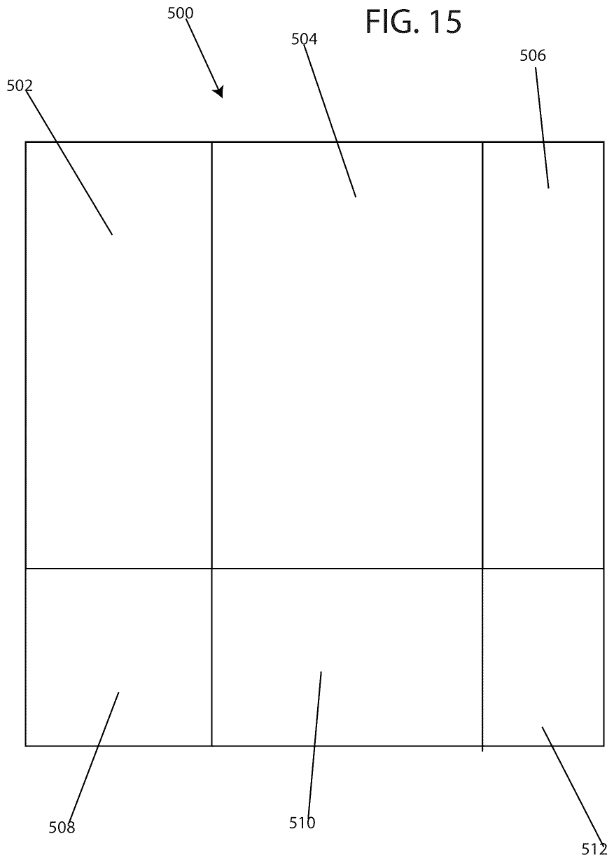

FIG. 15 is a view of a screen 500 of the user where there is a picture of the user in region 504, with a view of a map in region 502, a view of a message board in region 506. Other regions such as region 508 is a listing of the user's hobbies, while region 510 is a listing of the user's connections, while region 512 is a listing of their profile including the user's characteristics such as height, weight, age, and other preferences input in the process shown in FIG. 1. In this way this profile can show other users the interests and hobbies of a particular user, as well as show that user how they appear to other users.

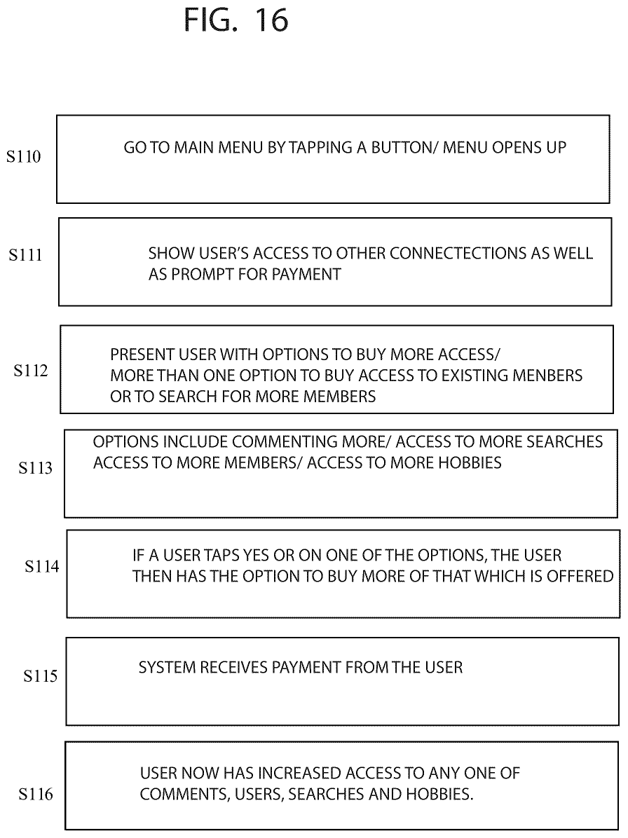

FIG. 16 is a view of a flow chart for the process for a connect more process wherein if the user pays for additional access, that user has additional searching capabilities as well as additional advertisements to additional users. For example, the process starts in step S110 wherein the user can go to the main menu in step S110. Next, in step S111 the user is shown access to additional connections as well as a prompt for payment for the enhanced profile and enhanced searching capabilities. Next, in step S112 the user is presented with options to buy more access such as access to existing members or for access to additional members. Next, in step S113 the process includes options to allow the user to comment more and access more searches for more members. Next, in step S113 the process allows for options including enhanced commenting and more access to more searches and more access to additional hobbies. Next, in step S114 if a user taps yes on one of the options the user then has the option to buy more of that of what is offered. Next, in step S115 the system (such as microprocessor) can receive payment from the user. Next, in step s116 the user has increased access to any one of the additional comments, users, searches and hobbies.

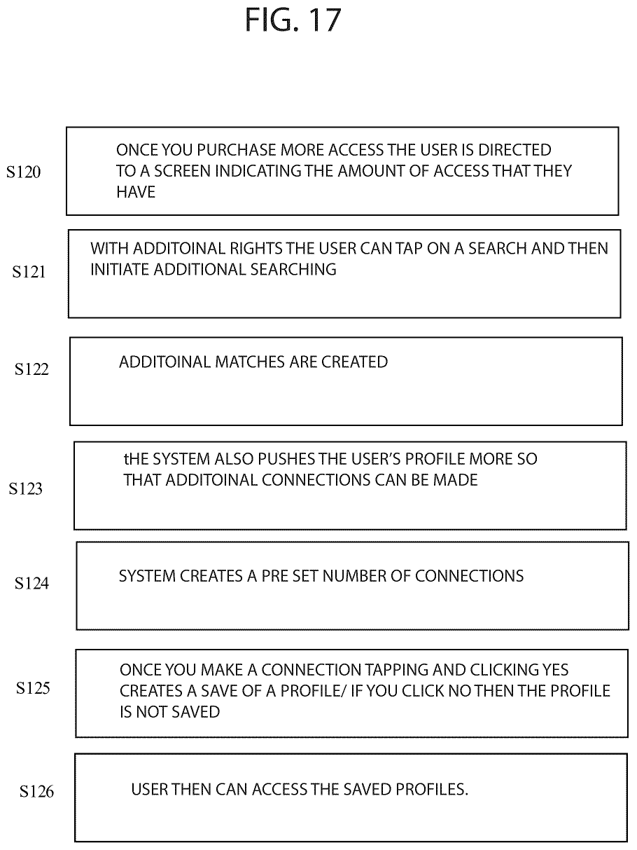

FIG. 17 shows the process wherein once the user purchases more access the user can then access more matches, connections, and profiles. For example, the system starts this process in step S120 wherein the user can purchase more access and are then directed to the additional access that they have. Next, in step S121 the process includes presenting the user with the additional rights so that the user can then tap on an additional search and then initiate additional searching. Next, in step S122 additional matches are created. Next, in step S1223 the system also pushes the users account profile so that additional connections can be made by other users searching that account profile. Next, in step S124 the system creates a pre-set number of connections. Next, in step S125 once these connections are made the user is allowed to save the profiles of the other users that they connected with provided the user has paid for this additional access and has credits. If the user does not have credits or has not paid for this additional access, then the user cannot save these additional profiles. Next, in step S126 the user can then access these saved profiles.

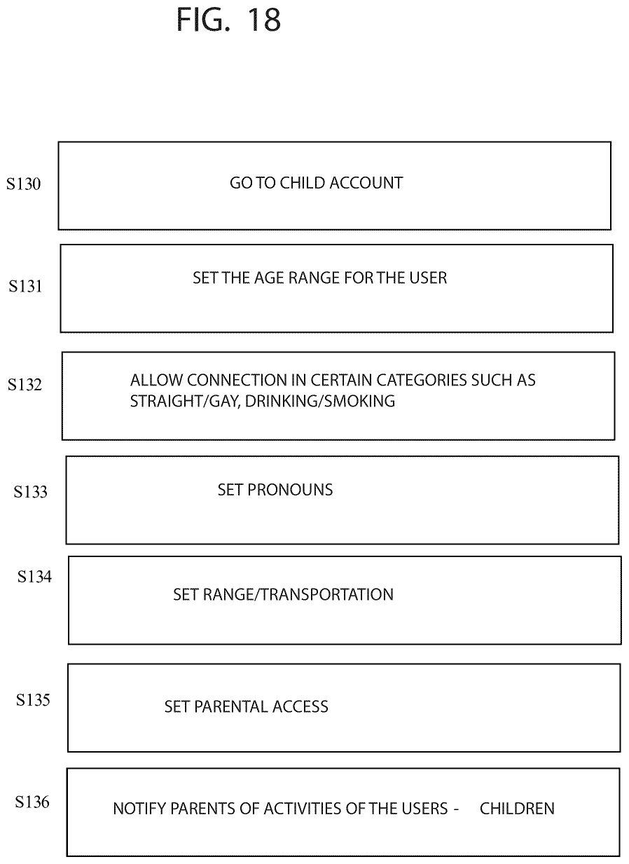

FIG. 18 shows the process for setting up a child account in step S130. For example, the user can set the age range for the users in step S131. Next, in step s132 the system can allow connection between users in certain categories such as straight/gay drinking, smoking etc. Next in step S133 the system allows the user to set their pronouns. Next, in step S134 the system allows the user to set their range (geographic range) and their transportation modes, such as whether the user drives, or needs to take the bus, or have others drive or take other forms of public transportation. Next, in step S135 the system can allow for setting parental notifications and access. Next in step S136 parents are notified of the user's activities, particularly activities in certain categories.

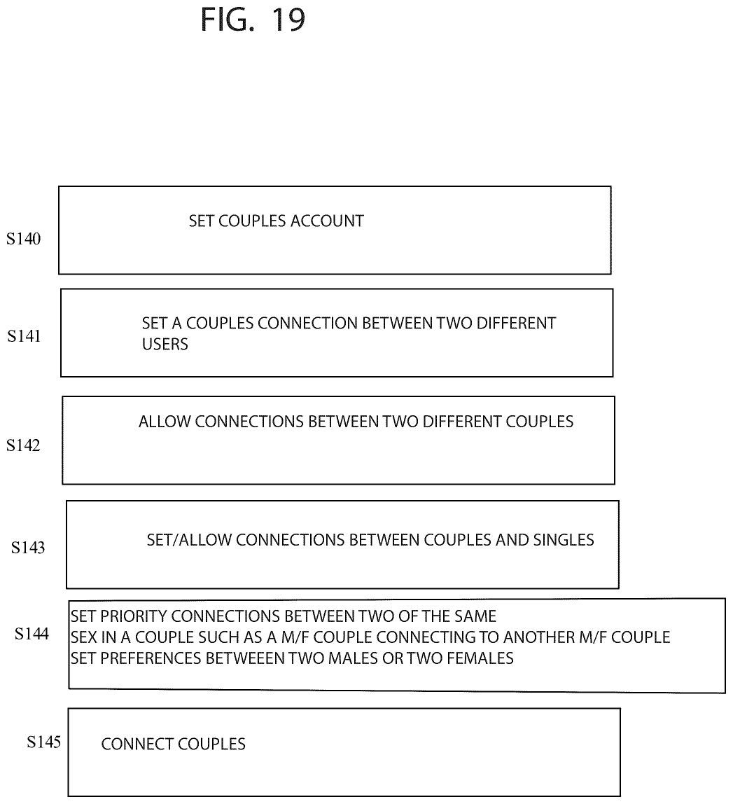

FIG. 19 sets the process for allowing couples to register as an account. For example, in step S140 the system allows the users to set up a couples account. This starts when two users are joined together as a single couple in step S141. Next, in step S142, the system allows for the connection between two different couples. Next, in step S143 the system allows for connections between couples and singles. Next, in step S144 the system can set a priority connection between two users, with one user in a single couple and another user who is part of another couple. Thus, the priority can be based upon a Male-Male connection between the couples, so that matching males is given greater weight than matching females, or vice versa. In this way the categories or profiles that are used to match are given greater weight in the priority match (such as male-male) or female—female so that if there is a priority match between two people across couples, this creates an accurate match of the two different couples. Next, in step s145 there can be a connection between the two couples.

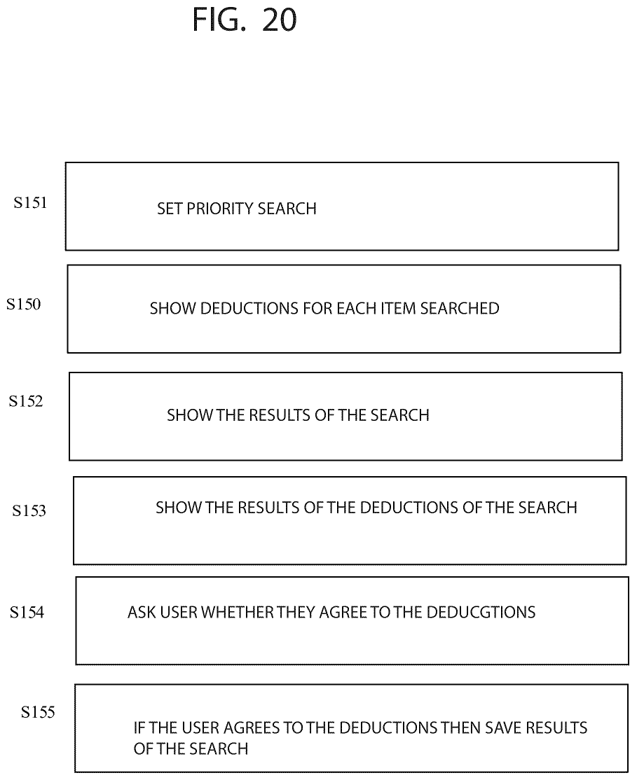

Next, in FIG. 20 this outlines the steps for a priority search across profiles. This process starts in step S151 wherein the user initiates a priority search. Next, in step S150 the system shows the suggested deductions in points/credit or money for each item searched. If the user agrees to the deductions, the system in step S153 shows the user the results of the search and the results of the deductions for the search. Next, in step S154 the system confirms whether the user agrees to the deductions in the search. Next, in step S155 the user agrees to the deductions and then is allowed to save the results of the search into the system.

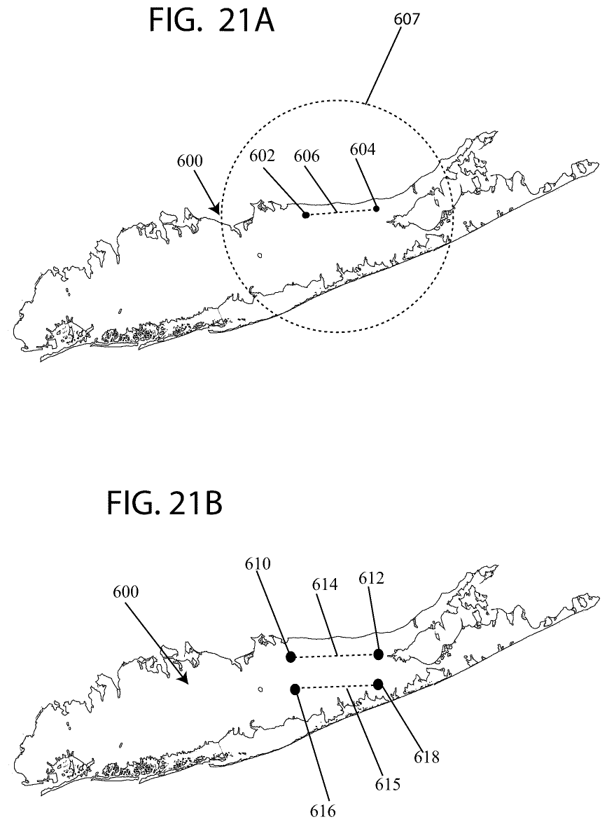

FIG. 21A shows a view of a map of Long Island 600 which includes a line 606 having two ends 602 and 604 which define the line 606. This line 606 is configured to set the range for searching for parties to connect with using the application. As shown with the map 600, this map which is of Long Island, shows that a radial search such as with a circle 607 may be insufficient, because this radial search of a circle could bring forth regions that are not on Long Island such as in Westchester County or in Connecticut. As there are no direct paths to Westchester or Connecticut without travelling over a bridge, it would be impractical to search using a radial map or circle 607.

FIG. 21B shows map 600 which also shows two lines for defining an area for searching. For example, there is line 614 which has end points 610 and 612 defining the west and eastern tips from a northern boundary. In addition, there is line 615 which has end points 616 and 618 which define the western and eastern boundaries of the southern boundary. Thus, the search for connecting with other users would be conducted within the metes and bounds of points 610, 612, 616, and 618.

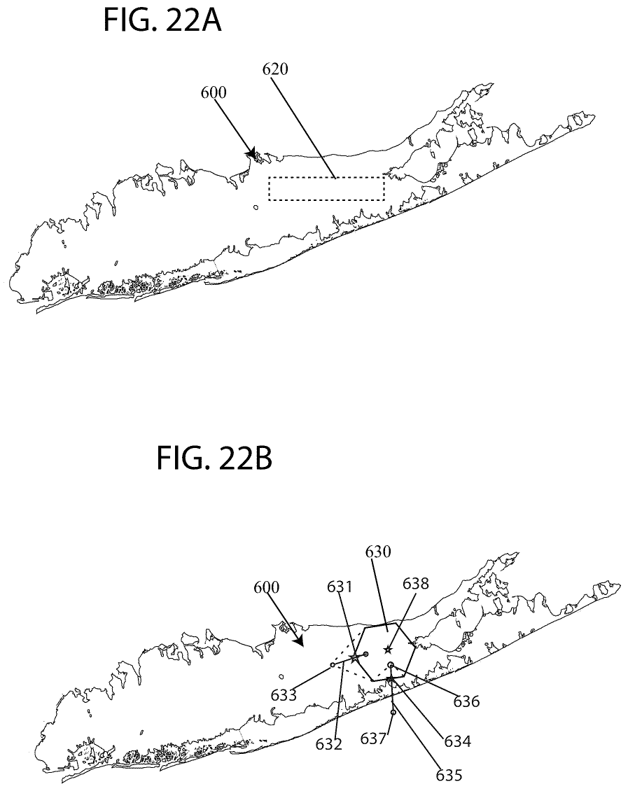

FIG. 22A shows a view of a map for searching which has a singular substantially rectangular search area 620 which defines the metes and bounds for searching for other users to connect with the primary user. The term substantially is used to describe a shape that is within at least that shape +/−10% of that shape. For example, if the shape is a rectangle, then it could include a rectangle having rounded corners such that the total area of the rounded rectangle is within the shape or size of the original rectangle +/−10%. Other shapes can be used such as an oval, circle, rhombus, hexagon, octagon, triangle or other suitable shapes. Any one of these shapes can be only substantially that shape (+/−10% variance of that shape). The user can then move any one of the points to modify this shape as well.

FIG. 22B shows a view of a map for another type of shape which is a non-rectangular shape 630 for defining the searching area. Thus, there is disclosed a system for searching using nontraditional search areas for searching to match users with other users or other events. Some of these non-rectangular shapes can be a pentagon, octagon, hexagon, rhombus, or any other suitable shape. These shapes can be adjusted as shown wherein an adjustment point 631 is shown as being adjustable to point 633 along adjustment bar 632. In addition, adjustment point 634 is shown as adjustable along adjustment bar 635 to point 636 (or alternatively out to point 637) along bar 635. These dashed lines are shown to show the new shape of the searchable area. This searchable area in FIG. 22B as well as all of the searchable areas in FIGS. 21A-24 can be adjusted to provide customizable search areas for both users and businesses to modify their search areas for other users or businesses. Any one of these search parameters or areas can not only be adjusted in size, they can be adjusted in angle by allowing for rotation of these search areas around a center point such as point 638. The modification of these shapes or zones can occur through a user dragging a mouse point using a mouse or by placing their finger on a screen. The placement of the finger or mouse point on the screen allows for the movement of this point or for the creating of an adjustment bar such as bar 632 or bar 635 which allows for movement of the point along this bar. The placement of the cursor through either a mouse click, or a finger placed on a screen then allows for rotation of this shape around a central point such as point 638.

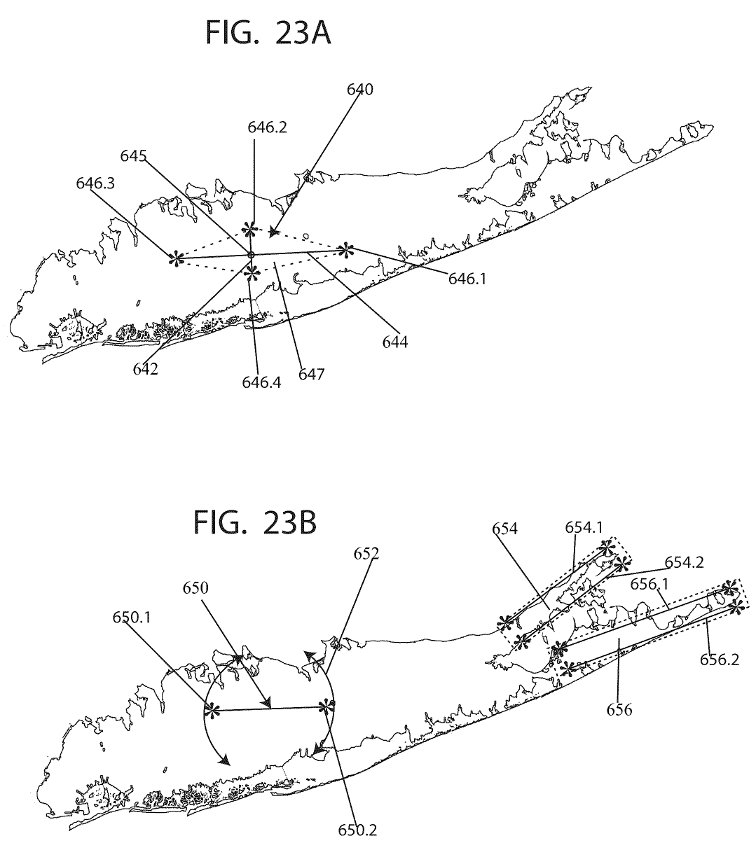

FIG. 23A is a view of another map having both east west lines and north south lines for example on this view of map 640 there is an east-west line 644 setting out the east-west parameters, and a substantially north-south line setting forth the north to south parameters for the search. The distances on these lines can be adjustable. In addition, while each of these lines is described as either east-west or north-south, these lines can be alternatively set at any angle. In this view the lines are presented as perpendicular or substantially perpendicular. For purposes of defining substantially, this term is +/−10% or alternatively +/−10 degrees for purposes of an angle variance. In this view the lines or bars 642 and 644 are set with a center point 645 with end point shown. Each of these end points 646.1, 646.2, 646.3 and 646.4 is selectively adjustable. The search zone 647 is shown being defined by end points 646.1, 646.2, 646.2, 646.2, 646.3, and 646.4.

FIG. 23B is a view of a line having angular adjustability and two additional zones of searching. In this map, there is a line 650 which has semi circular arrows 652 indicating that the angle of this search line 650 can be adjusted angularly by a user. The user can simply click on an end of the line and drag it in an angular manner to rotate the line. There are also shown two different search zones, with a first search zone 654 being bound by lines 654.1 and 654.2. Each of these lines can be drawn once the search zone is selected. With a first search line 654.1 being drawn first, and a second search line 654.2 being drawn second. In addition, in the second zone that of 656, this second zone is selected after the first zone is created. Once the second zone 656 is selected, a first line 656.1 is created, and then a second line 656.2 is then created. These lines then set their respective search zones. A third search zone can be created by line 650 as well.

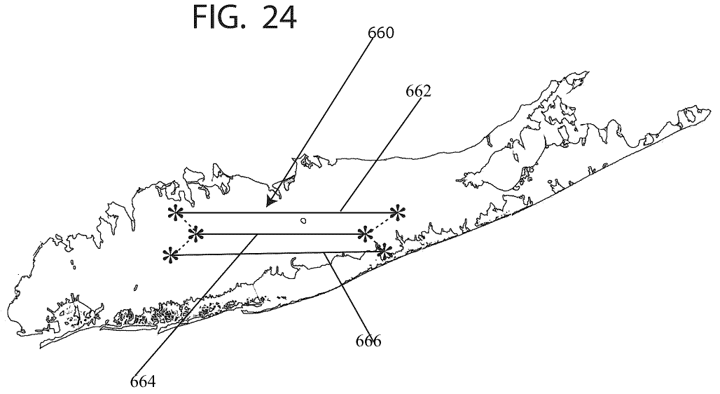

FIG. 24 is a view of a map having multiple different search lines. For example, in this map 660, there are shown lines 662, 664, and 666. These three search lines 662, 664, and 666 can be used to set an irregularly shaped search zone as shown by the dashed lines.

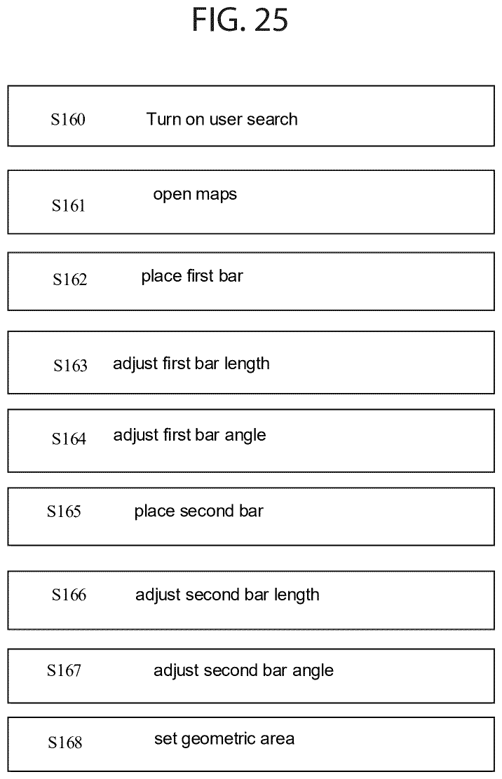

FIG. 25 is a flow chart for the additional steps for searching based upon lines. For example, there is shown in step S160 wherein the user can turn on the search function. Next in step S161 the user can open the maps. Next, in step S162 the user can place their first bar for searching. Next in step S163 the user can adjust the first bar length. Next, in step S164 the user can adjust the first bar angle. Next, in step S165, the user can place the second bar. Next, in step S166 the user can adjust the second bar length. Next in step S167, the user can set the second bar angle. Next, once the second bar or line is set, the user can set the geometric area for the search. The placement of these search bars and zones makes it easier for a user to search for a particular location which is customized. The placement of these search bars and/or zones corresponds to location points on a map such as GPS points or longitudinal and latitudinal points on a map or coordinates so that it allows the user to graphically (through manipulating a map) set a customized zone for searching. The placement of these bars or zones (see bar 606 in FIG. 21A) or zones such as radial zone 607 or circle allows the user to graphically customize the search zone of interest. Alternative search blocks could be via the search rectangle 620 in FIG. 22A or search shape 630 in FIG. 22B. These coordinates, GPS points or longitudinal or latitudinal coordinates can then be stored in an associated memory such as memory 203 and/or memory 223 in a non-transitory manner and then stored in a database such as in database server 120. Thus, this system allows the user to graphically set search zones on a map to automatically search in these zones and then store these pre-defined search zones in memory as well as in a database.

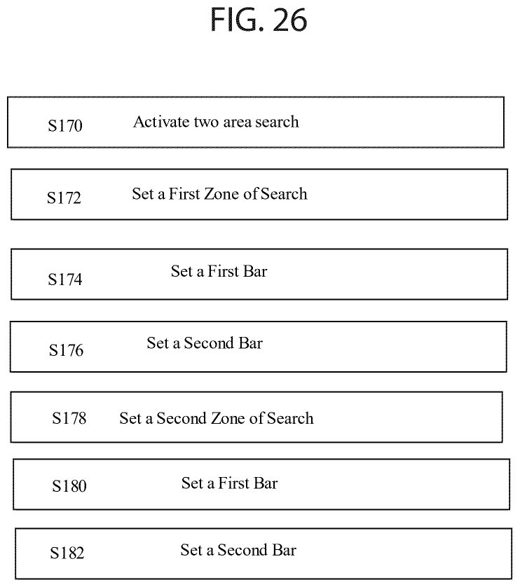

FIG. 26 is a flow chart for the steps for simultaneously searching in two different zones. For example, in step S170 the user can activate two areas for searching. Next, in step S172 the user can set a first zone for searching such as zone 654 (See FIG. 23B). Next in step S174 the user can set a first bar such as bar 654.1. Next, in step S176 the user can set the second bar such as bar 654.2 to establish the first zone of the search. Next in step S178 the user can set the second zone 656 of the search. Next, in step S180 the user can set the first bar 656.1 for the search. Next, in step S182 the user can set the second bar 656.2 for the search to create the second area for the search. Thus, while this searching system can be used with the system and process listed above in any one of FIGS. 1-28, this search system can also be used with other types of search engines and systems so that this unique searching system can be utilized as a separate stand-alone searching system. The coordinates of these search zones on the map can be in the form of longitudinal or latitudinal coordinates, GPS coordinates or any other suitable coordinates such as an address to define these two separate search zones. These search zones are stored in a non-transitory manner in a suitable memory such as memory 203 or memory 223 and then stored in a database such as in database server 120.

Thus, the system is designed to automatically re-rank hobbies, and accordingly then re-rank matches between the users based upon a re-ranking of the hobbies. The system and process then can be configured to match people and hobbies together.

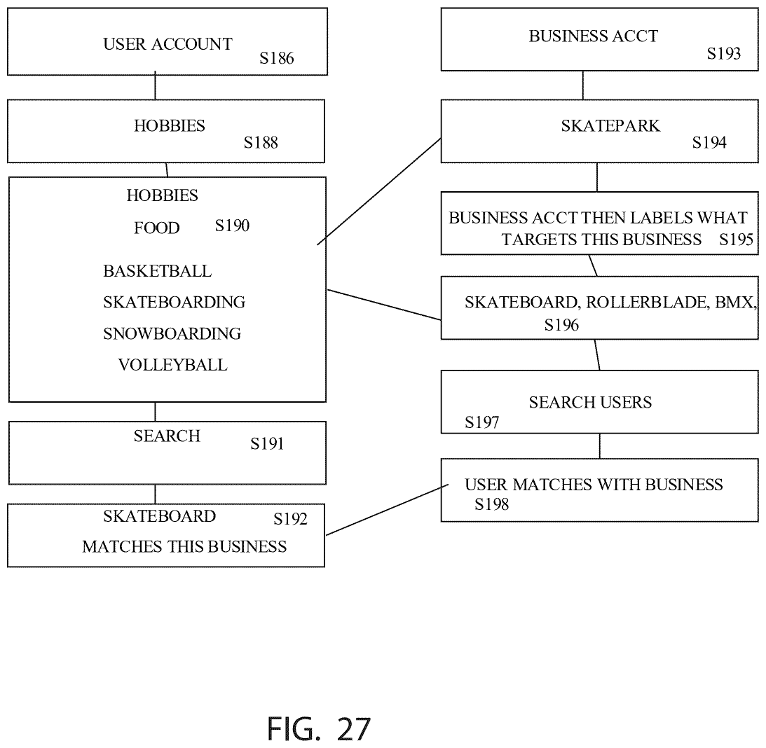

FIG. 27 is a flow chart for connecting users and businesses with hobbies. In this embodiment there is a flow chart which starts with a user setting their account in step S186. Next, in step S188 the user lists their hobbies. Next, in step S190 the user can rank their hobbies which can include anything from food, basketball, skateboarding, snowboarding, volleyball or any other type of hobby. Next, in step S191 the user can search for these hobbies for a match and then in step S192 match a particular hobby such as skateboarding with a particular business.

Alternatively business owners can register their business in step S193. Next, in step S194 the user can list their business. The business owner can then provide keywords or labels as to what should be the targets for this business in step S195. In step S196 the characteristics that are listed by the business are then matched with the interests of the users. Next, in step S197 the system can search for users by matching these interests. Next, in step S198 the user then matches with the business so that the users and the businesses can be matched together.

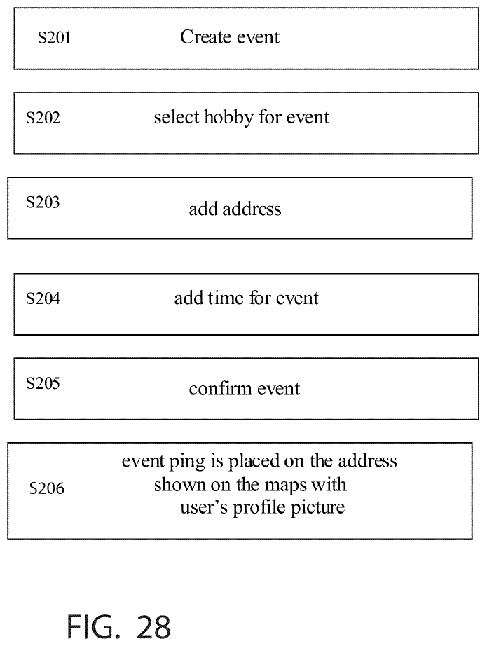

FIG. 28 shows a flow chart for either users or businesses for creating an event. For example, in step S201 the user can create an event. The characteristics of this event can be based upon time, place (location), parties (people) that are present at the event, as well as hobbies. For example, in step S202 the user can select a hobby for the event such as skateboarding, basketball, cooking etc. Next, in step S203 the user can add the address of the location of the event. Next, in strep S204 the user can add the time for the event. Next, in step S205 the user can confirm the event by confirming the information on the event. Next, in step S206 the event ping or location is placed on a map so as to set the initial location of the event. From this initial location the ranges of locations can be placed on the map such as in FIGS. 21A-24.

For all of these processes, each of the set of instructions can be stored in a memory such as memory 203 and/or 223 in a non-transitory manner.

Accordingly, while at least one embodiment of the present invention has been shown and described, it is to be understood that many changes and modifications may be made thereunto without departing from the spirit and scope of the invention as defined in the appended claims.

What is claimed is:

1. A process for matching users with an event over a computer network having a memory, a microprocessor and a database, the process comprising:
registering a user on the computer network and storing the user information including the user's hobbies and location in the memory in a database;
registering an event on the computer network and storing said user information including the event activities and location in the memory in the database; and
matching the user with the event based upon the user's hobbies and location and the event's activities and location.

2. The process as in claim 1 further comprising the step of registering at least one additional user on the computer network and storing the at least one additional user's information including the user's hobbies and location in the memory in the database.

3. The process as in claim 2, further comprising the step of having a user drop a marker on a map and then indicating an activity that is desired by that user.

4. The process as in claim 3, further comprising the step of having at least one user inform other users of an activity.

5. The process as in claim 4, further comprising the step of matching a user with a plurality of activities, and then setting a weighted priority for each activity.

6. The process as in claim 5, further comprising the step of matching a user with at least one additional user based upon said weighted priorities for each activity.

7. The process as in claim 6, further comprising the step of tracking the frequency of a user and his presence in a location.

8. The process as in claim 6, further comprising the step of tracking the frequency of the user's use of an activity.

9. The process as in claim 6, further comprising the step of providing a first weight to a first activity, and then providing a second weight to a second activity, wherein said second weight is different from said first weight and then storing said weights in the memory and in the database.

10. The process as in claim 9, further comprising the step of setting an area on a map to indicate a location of an activity.

11. The process as in claim 10, wherein said process of setting an area on a map comprises setting a circle having a radius which extends out from a pre-set particular location on a map.

12. The process as in claim 10, further comprising the step of setting an area on a map by setting a substantially rectangular area on the map said rectangular area being defined by a plurality of coordinates stored in a memory in a non-transitory manner.

13. The process as in claim 10, further comprising the step of setting a search zone by setting at least two separate substantially parallel lines on a map and then storing said search zone in a non-transitory manner in the memory in said database.

14. The process as in claim 10, further comprising the step of setting a search zone by setting at least two separate substantially perpendicular lines on a map and then storing said search zone in the memory in said database.

15. The process as in claim 10, wherein said step of setting a search area comprises setting a search line on a screen having first point, a second intermediate point and a third point opposite the first point, wherein at least one of the first point and the second point are adjustable in location, and wherein the search line is rotatable around the second intermediate point and wherein said search line is movable by adjusting a location of the intermediate point on the bar.

16. The process as in claim 13, further comprising the step of adjusting a length of at least one of said substantially parallel lines to adjust a set of coordinates reflected by a length of at least one of said substantially parallel lines.

17. The process as in claim 13, further comprising adjusting at least one angle of at least one line to adjust a plurality of coordinates which are reflected by said at least one line.

18. The process as in claim 1, further comprising setting a first area for searching for activities or people on a map and then setting a second area for searching for activities or people on a map.

19. The process as in claim 18, wherein said step of setting a first area for searching comprises setting a first line, and then setting a second line to define said first area for searching.

20. The process as in claim 19, wherein each of said first area for searching and said second area for searching represent a plurality of coordinates on a map, wherein a first set of coordinates for said first area for searching is stored in said memory in a non-transitory manner, and a second set of coordinates for said second area for searching is stored in said memory jn a non-transitory manner.
